(19) United States
(12) Patent Application Publication
(10) Pub. No.: US 2020/0216131 A1
(43) Pub. Date: Jul. 9, 2020

(54) TISSUE HOLDER FOR BICYCLE

(71) Applicant: Kenneth James Samel, Windham, NH (US)

(72) Inventor: Kenneth James Samel, Windham, NH (US)

(21) Appl. No.: 16/720,104

(22) Filed: Dec. 19, 2019

Related U.S. Application Data
(60) Provisional application No. 62/789,289, filed on Jan. 7, 2019.

(51) Int. Cl. B62J 11/00; B62J 7/08; B62J 9/00; B65D 83/08

(52) U.S. Cl. CPC B62J 11/00; B65D 83/0847; B62J 9/005; B62J 7/08

(57) ABSTRACT

A tissue holder for a bicycle includes a hollow body in which a tissue package is placed. A center opening or side opening in the body provides access to the tissue package such that tissues can be removed individually without removing the secured tissue package from the tissue holder. The hollow body may have an open end via which the tissue package is inserted into the hollow body and a closed end having an aerodynamic shape. Restraining projections help to secure the tissue package inside the body. A contoured mounting adapter and adjustable means of attachment enable the tissue holder to be configured for various sizes and types of bicycles and bicycle tubes.

### BACKGROUND

Participants in outdoor recreational activities such as cycling may experience rhinorrhea and watery eyes due to exposure to wind and cold temperatures. Pocket-size packages of facial tissues are widely available but accessing a tissue requires interruption of vigorous recreational activities such as cycling. For example, reaching into a fanny pack or the pockets of form-fitting cycling clothing to retrieve a single tissue is usually impractical. Typically, the entire tissue package must be removed from the pack or pocket and subsequently reinserted after a single tissue is retrieved. Because use of both hands is generally required to handle the tissue package, the rider must either stop or risk accident and injury.

### SUMMARY

All the features described herein can be combined in any technically possible way. Inventive aspects are described and illustrated using examples rather than alternative embodiments that exclude features from other examples.

In accordance with some implementations a tissue holder comprises: a hollow body comprising a first compartment adapted to hold a tissue package and a second compartment adapted to hold used tissues; the hollow body comprising a first opening adapted to allow removal of individual tissues from a tissue package disposed within the first compartment and a second opening via which used tissues are placed into the second compartment. Some implementations comprise a hinged lid that covers the first opening and the second opening in a closed position.

In accordance with some implementations a tissue holder comprises: a hollow body comprising an opening adapted to allow removal of individual tissues from a tissue package disposed within the hollow body; a hinged lid that covers the opening in a closed position; means for attaching the hollow body to a structural member; and a mounting adapter configured to be disposed between the hollow body and the structural member.

In accordance with some implementations an apparatus comprises: a hollow body comprising an open distal end, a closed distal end, a top wall connected with a bottom wall via a first side wall and a second side wall, and an opening adapted to allow removal of individual tissues from a tissue package within the hollow body. In some implementations the hollow body comprises hooked projections via which the hollow body can be secured to a structure via elastic tensioners. In some implementations the hollow body comprises multiple sets of openings via which the hollow body can be secured to a structure using straps. In some implementations the opening comprises transverse lobes. In some implementations the opening comprises elongating lobes. In some implementations the opening is centered on the top wall. In some implementations the opening is centered proximate to where the top wall meets the side wall. In some implementations the hollow body comprises restraining projections at the open distal end. In some implementations the bottom wall is concave. In some implementations the first and second side walls are convex. In some implementations the top wall is convex. Some implementations further comprise a mounting adapter having a convex side and a concave side, wherein the convex side comprises a curvature matching the bottom wall of the hollow body. In some implementations the mounting adapter comprises an alignment insert on the convex side and the hollow body includes an alignment slot on the bottom wall, the alignment insert fitting into the alignment slot. In some implementations the mounting adapter comprises a projection tab at a distal end and the hollow body comprises a slot at the open distal end, the projection tab fitting into the slot. Some implementations comprise a lid that covers the opening in a closed position. Some implementations comprise a hinge via which the lid is pivotally connected to the hollow body. In some implementations the lid comprises a latch tab and the hollow body comprises a latch slot, the latch tab fitting into the latch slot.

### BRIEF DESCRIPTION OF THE FIGURES

FIG. 1 illustrates a side-opening tissue holder mounted on a bicycle.

FIG. 2 is a projection view of the side-opening tissue holder of FIG. 1.

FIG. 3 is a side view of the side-opening tissue holder of FIG. 2.

FIG. 4 is a sectional view of the side-opening tissue holder of FIG. 3.

FIG. 5 is a projection of a side-opening tissue holder with a mounting adapter.

FIG. 6 is a side view of the side-opening tissue holder of FIG. 5 with the mounting adapter installed.

FIG. 7 is a projection of a side-opening tissue holder with mounting straps.

FIG. 8 is a side view of the side-opening tissue holder with straps of FIG. 7.

FIG. 9 is a projection of a side-opening tissue holder with mounting adapter and mounting straps.

FIG. 10 is a projection of the side-opening tissue holder of FIG. 9 with the mounting adapter installed.

FIG. 11 is a side view of the side-opening tissue holder of FIG. 10.

FIG. 12 is a projection of a top-opening tissue holder.

FIG. 13 is a side view of the top-opening tissue holder of FIG. 12.

FIG. 14 is a projection of a top-opening tissue holder with a mounting adapter.

FIG. 15 is a side view of the top-opening tissue holder of FIG. 14 with the mounting adapter installed.

FIG. 16 is a projection of a top-opening tissue holder with mounting straps.

FIG. 17 is a side view of the top-opening tissue holder with straps of FIG. 16.

FIG. 18 is a projection of a top-opening tissue holder with mounting adapter and mounting straps.

FIG. 19 is a projection of the top-opening tissue holder of FIG. 18 with the mounting adapter installed.

FIG. 20 is a side view of the top-opening tissue holder of FIG. 19.

FIG. 21 is a projection of a top-opening tissue holder with lid.

FIG. 22 is a side view of the top-opening tissue holder of FIG. 21.

FIG. 23 is a projection of a top-opening tissue holder with lid and a mounting adapter.

FIG. 24 is a side view of the top-opening tissue holder of FIG. 23 with the mounting adapter installed.

FIG. 25 is a projection of a top-opening tissue holder with lid and mounting straps.

FIG. 26 is a side view of the top-opening tissue holder with lid and straps of FIG. 25.

FIG. 27 is a projection of a top-opening tissue holder with lid, mounting adapter, and mounting straps.

FIG. 28 is a projection of the top-opening tissue holder of FIG. 27 with the mounting adapter installed.

FIG. 29 is a side view of the top-opening tissue holder of FIG. 28.

FIG. 30 is a projection of a side-opening tissue holder with a lid and compartment for used tissues.

FIG. 31 is a side view of the tissue holder with a lid and compartment for used tissues of FIG. 30.

### DETAILED DESCRIPTION

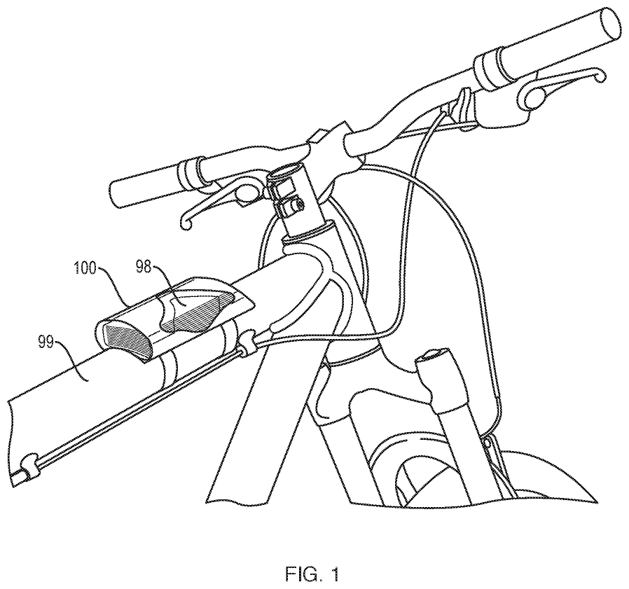

Various implementations of a lightweight aerodynamic tissue holder that can be adapted to fit different sizes and types of bicycles are disclosed herein. FIG. 1 illustrates a side-opening tissue holder 100 mounted on a tube 99 that is part of a bicycle frame. The tissue holder 100 has a hollow body in which a tissue package 98 is placed. An opening in the tissue holder provides access to an opening flap of the tissue package such that individual tissues can be removed from the tissue package through the opening. Different types of openings may be implemented to accommodate different types of tissue packages. Lightweight materials may be used such that the tissue holder does not add significant weight to the bicycle (e.g. 0.03 kg). For example, the tissue holder could be manufactured from polycarbonate with injection molding or other suitable manufacturing techniques. It should be understood, however, that the inventive aspects are not limited to tissue holders for bicycles. The tissue holder is usable with a wide variety of equipment having tubular and non-tubular structural members. For example, and without limitation, the tissue holder may be used with a walker or wheelchair or attached to the arm of a runner, hiker, skater or skier.

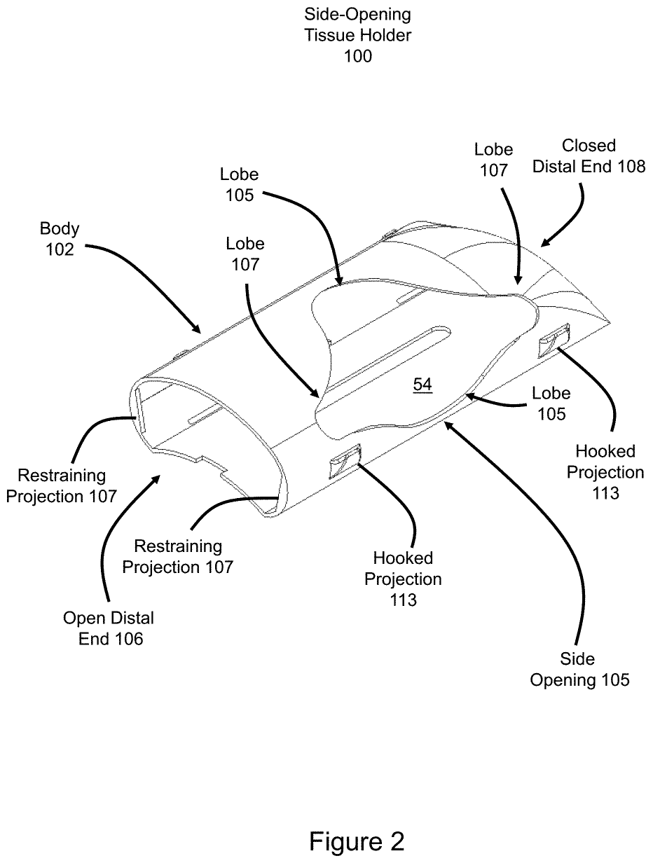

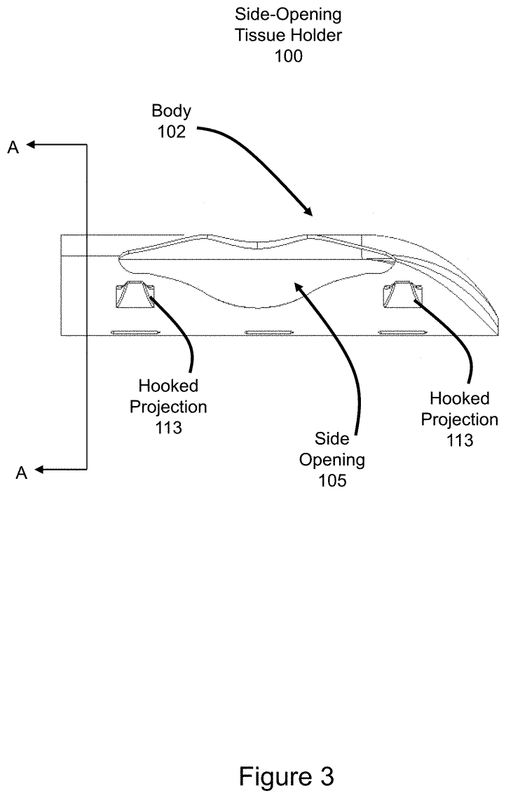

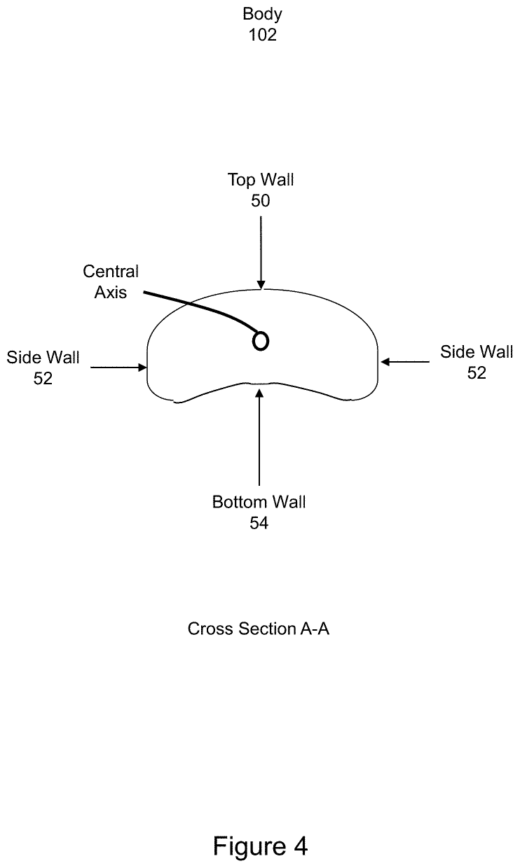

FIGS. 2 through 4 illustrate an implementation of the side-opening tissue holder 100 that is suitable for mounting to a bicycle and other equipment. The side-opening tissue holder 100 includes a hollow body 102 with a top wall 50, a bottom wall 54, and two side walls 52. The body 102 may be formed as a single component from a single piece of material, e.g. via extrusion, injection molding, or 3D printing. The interior of the hollow body retains a standard pocket-size tissue package that holds multiple stacked and/or folded tissues and has a side-flap opening. An example of a side-flap pocket-size tissue package is shown in U.S. Pat. No. 2,621,788A which is incorporated by reference. Two sets of hooked projections 113 on the side walls enable the body to be secured to a bicycle or other equipment via elastics, O-ring bands, or other elastic tensioners. When properly mounted, an individual tissue can be extracted from the retained side-flap tissue package via a side opening 105 with one hand without simultaneously removing additional tissues or the entire tissue package.

The side opening 105 is offset relative to a central axis or plane that bisects the body, e.g. centered near to where the top wall and side wall meet. The size, shape, and location of the side opening 105 may be selected as a design preference based on the opening flap of the tissue packages that will be used with the tissue holder. In the illustrated example the side opening 105 has roughly the same shape as the tissue package opening shown in U.S. Pat. No. 2,621,788A and a corresponding location. The side opening includes transverse lobes 105 that allow the rider to easily grasp a tissue while retaining the tissue package. Elongating lobes 107 positioned along the length of the tissue package accommodate a tissue that is being withdrawn and help to avoid tearing the tissue while it is pulled through the side opening. Sections between the lobes help to retain the tissue package within the body while a tissue is being pulled through the opening. In some implementations the tissue package is loaded and removed through the side opening 105 and both distal ends are closed.

The bottom wall 54 of the body 102 may be conformed to the shape of the top tube, down tube, or stem of the bicycle so the tissue holder can be securely attached in a location that can be easily reached by the rider. For example, the bottom wall 114 may be characterized by a curvature that matches or nearly matches the curvature of the tube to which the tissue holder is mounted. The exterior surface of the bottom wall that contacts the bicycle tube may include a soft and/or non-slip material such that the tissue holder does not damage the finish of the bicycle and stays firmly in place.

The shape of the hollow body 102 may facilitate retention of a loaded tissue package. The curved top wall 50 is connected to the bottom wall 54 via the side walls 52. The top wall 50 and side walls 52 are convex. The bottom wall 54 is concave. A height dimension is defined between the top wall 50 and bottom wall 54. A width dimension is defined between the side walls 52. A length dimension is defined between distal ends 106, 108. The width may be greater than the height and the length may be greater than the width. The hollow body 102 may have an internal volume substantially similar to a standard tissue package. Standard tissue packages typically have a roughly rectangular parallelepiped shape but can be deformed into other shapes because the tissues and plastic packaging are flexible. The internal dimensions of the hollow body are not necessarily rectangular parallelepiped in shape but may have a curvature that promotes a friction fit with a tissue package that is deformed into the internal shape of the body, e.g. such that much of the surface of the tissue package is in contact with the body. A uniform height such as the height of a tissue package may be maintained across the length and width of the body. A uniform width such as the width of a tissue package may be maintained substantially along the length of the body.

The hollow body 102 has an open distal end 106 via which a full tissue package is loaded, and via which an emptied tissue package is removed. Restraining projections 107 extend toward the interior of the hollow body at the open distal end to facilitate retaining the tissue package in place within the body. A tissue package is loaded into the body by sliding the tissue package beyond the restraining projections. Some implementations may include a feature to cover the open distal end 106.

A closed distal end 108 of the body 102 may be aerodynamically curved, e.g. such that the top wall is longer than the bottom wall. When mounted, the closed distal end 108 would face forward (in the direction of travel of the bicycle) while the open distal end 106 would face rearward. The closed distal end helps to prevent wind from causing the tissue package to slide out of the open distal end 106. Further, the aerodynamic shape of the closed distal end 108 helps to reduce drag associated with wind resistance. However, the closed distal end is not necessarily curved and, in some implementations, both distal ends are closed.

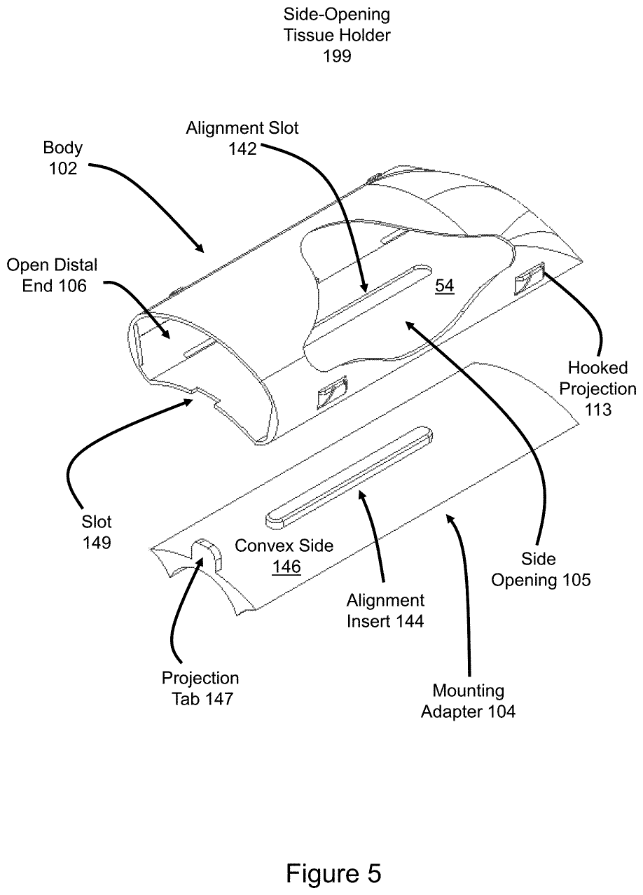

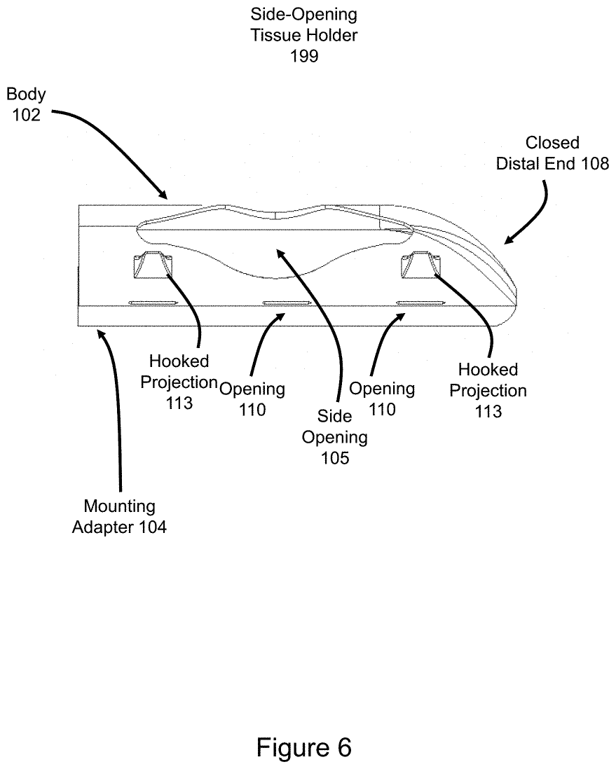

FIGS. 5 and 6 illustrate a side-opening tissue holder 199 including a hollow body 102 and a mounting adapter 104. The mounting adapter 104 adapts the hollow body 102 for mounting when the hollow body is not directly mounted to the bicycle. More specifically, the mounting adapter 104 may be placed between the body 102 and the structure to which the tissue holder is mounted in order to adapt the tissue holder to different curvatures. An alignment and/or interlocking feature such as an alignment slot 142 in the bottom wall 54 and an alignment insert 144 on the convex side 146 of the mounting adapter may help to secure the body in alignment with the mounting adapter. The convex side 146 of the mounting adapter has the same curvature as the bottom wall 54 of the body. A concave side (opposite the convex side 146) of the mounting adapter has the same curvature as the tube to which the tissue holder is being mounted. A projection tab 147 at a distal end of the mounting adapter 104 fits into a corresponding slot 149 in the open distal end 106 of the body to prevent the tissue holder from sliding relative to the mounting adapter and possibly to help retain the tissue package. FIG. 5 illustrates the mounting adapter 104 mounted against the body 102.

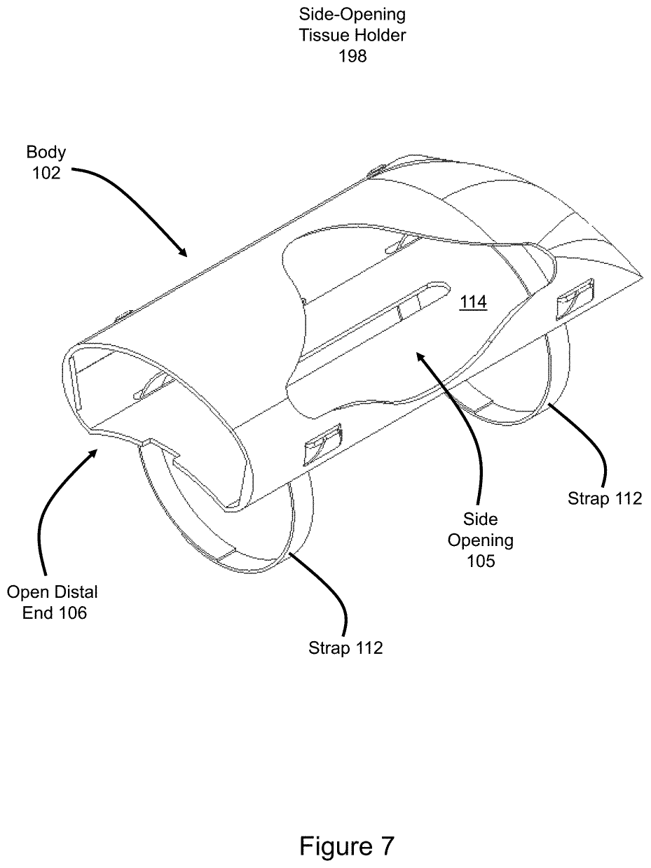

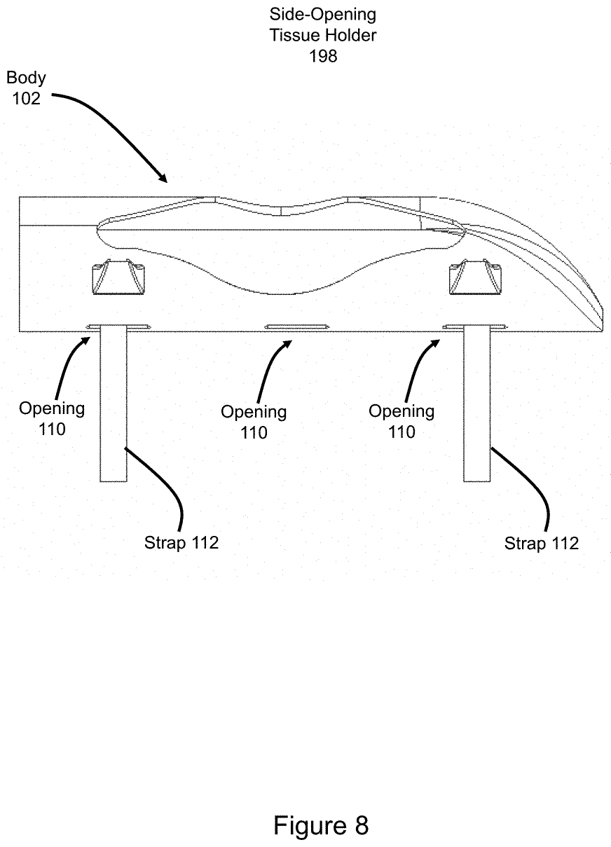

FIGS. 7 and 8 illustrate a side-opening tissue holder 198 with a hollow body 102 and straps 112. The body 102 includes six openings 110 (three pairs of openings on opposite side walls) through which the straps 112 are inserted. More particularly, two or three straps may be used, and pairs of openings may be selected based on the length of the tube to which the tissue holder will be affixed when two straps are used. Closer pairs of openings may be suitable for the stem whereas more distant pairs of openings may be suitable for longer tubes. Alternatives to straps may include, but are not limited to, clips, brackets, elastics, adhesive, fasteners, and any other of a wide variety of retention members and techniques.

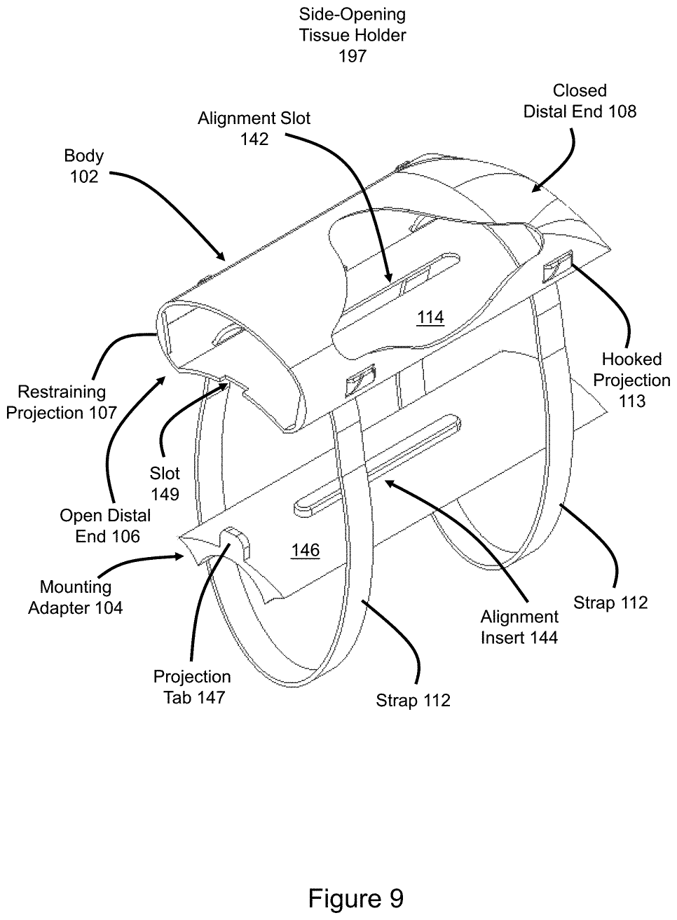

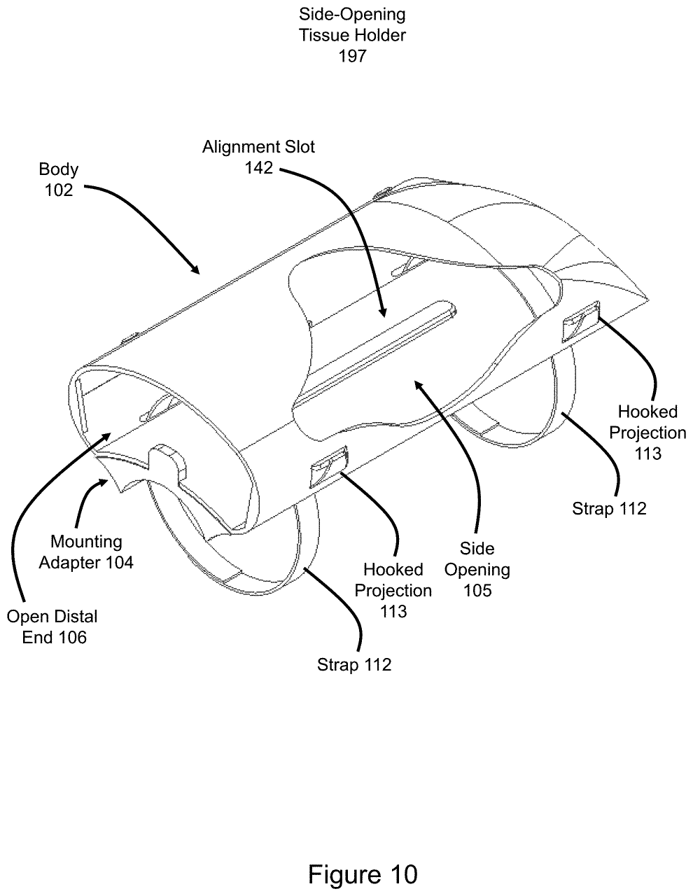

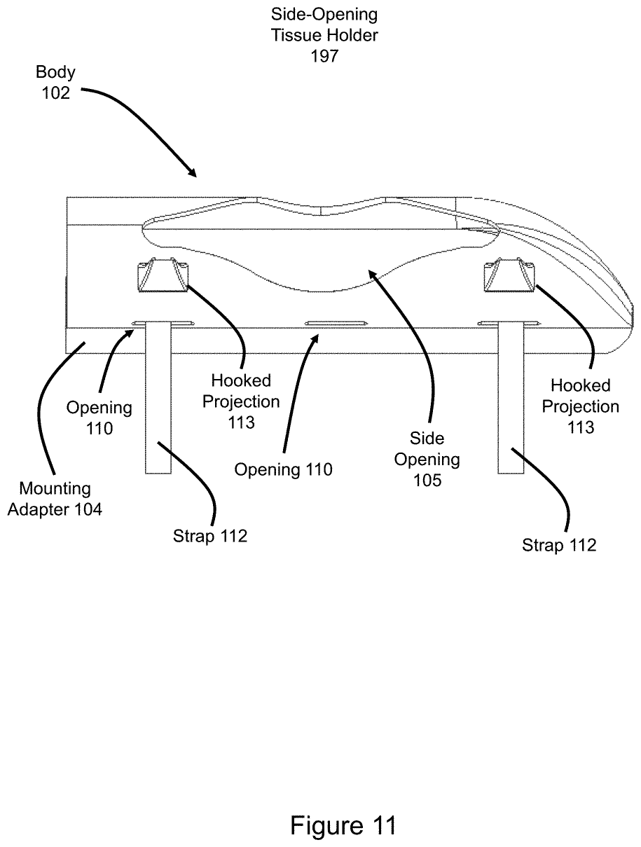

FIGS. 9 through 11 illustrate a side-opening tissue holder 197 with a hollow body 102, mounting adapter 104 and straps 112. FIG. 9 specifically illustrates the mounting adapter aligned with, but not mounted against, the body. FIGS. 10 and 11 illustrate the mounting adapter mounted against the body. The straps are fitted in the two outermost sets of openings and would extend around the tube to which the body is secured via the mounting adapter. The mounting adapter and straps function as already described above.

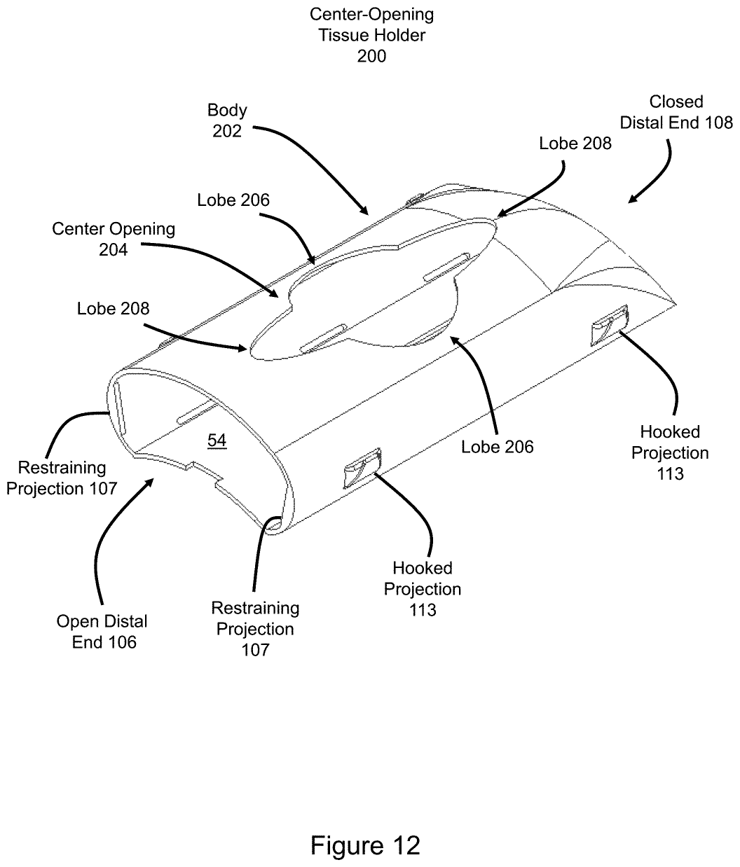

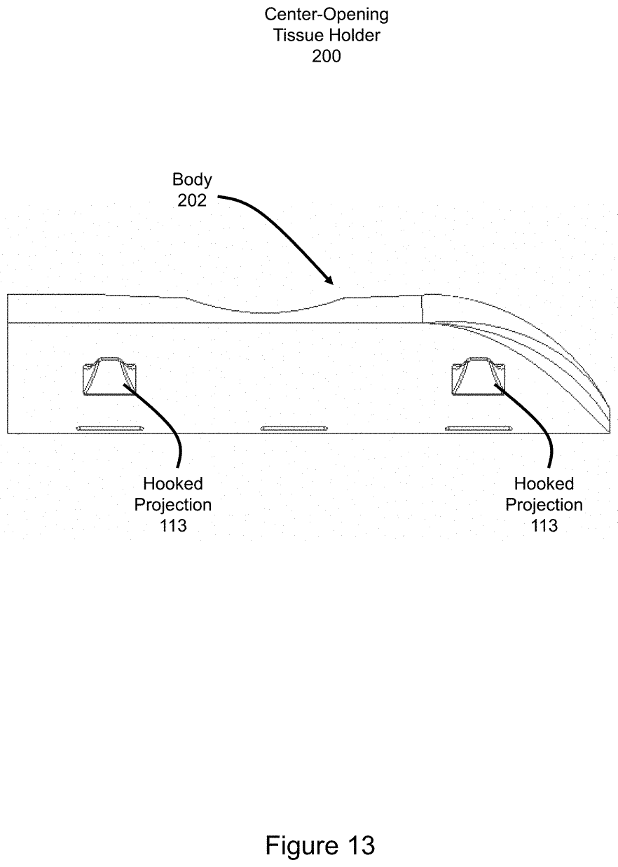

FIGS. 12 and 13 illustrate an implementation of a center-opening tissue holder 200 for use with standard top-center-opening tissue packages. The center-opening tissue holder 200 includes a hollow body 202 with substantially the same shape and features as body 102 (described above). However, body 202 includes a center opening 204 rather than a side opening. The body 202 is thus adapted for use with a standard pocket-size tissue package that holds multiple stacked and/or folded tissues and has a top-flap opening. The center opening 204 may be centered relative to a central axis or bisecting plane of the body e.g. centered with the top wall. The size, shape, and location of the center opening 204 may be selected as a design preference based on the opening of the tissue packages that will be used with the tissue holder. The center opening 204 includes transverse lobes 206 that facilitate grasping a tissue with rider's fingers. Elongating lobes 208 help to avoid tearing the tissue while it is pulled through the opening. In some implementations the tissue package is inserted and extracted through the center opening 204 rather than the open distal end 106, e.g. both distal ends may be closed.

Apart from the different opening locations, the center-opening tissue holder 200 may have any or all the features and shape described above regarding the side-opening tissue holder. Tissue packages may be inserted and removed via the open distal end 106. Restraining projections 107 may be provided to retain the tissue package in place within the body. An aerodynamically-shaped closed distal end 108 of the body 102 is located opposite to the open distal end 106. The bottom wall 54 of the body 202 is characterized by a curvature that may match or nearly match the curvature of the tube to which the tissue holder is mounted. The tissue holder may be temporarily or permanently affixed to the bicycle using hooked projections 113 and clips, brackets, elastics, O-rings, adhesive, fasteners, or any of a wide variety of elastic tensioners and techniques.

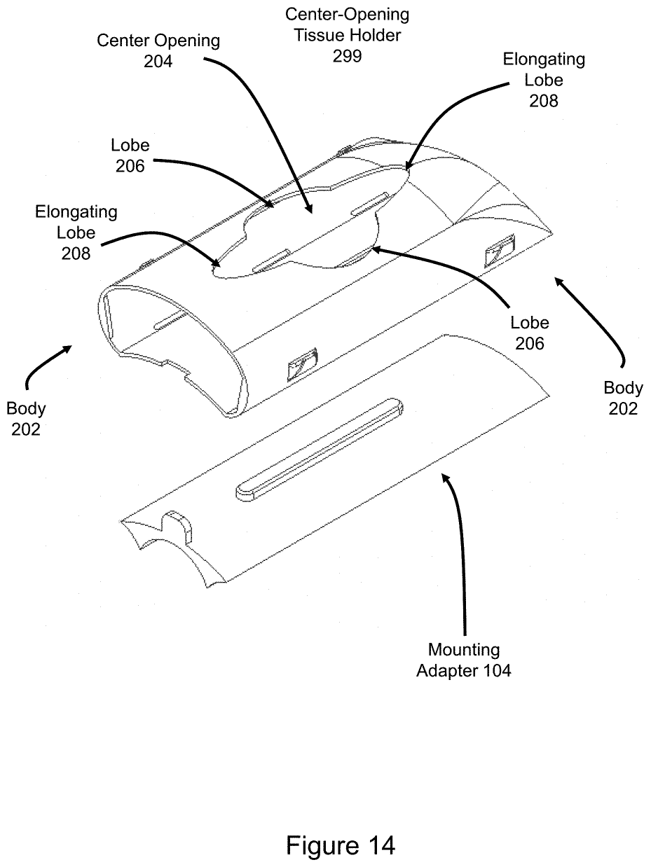

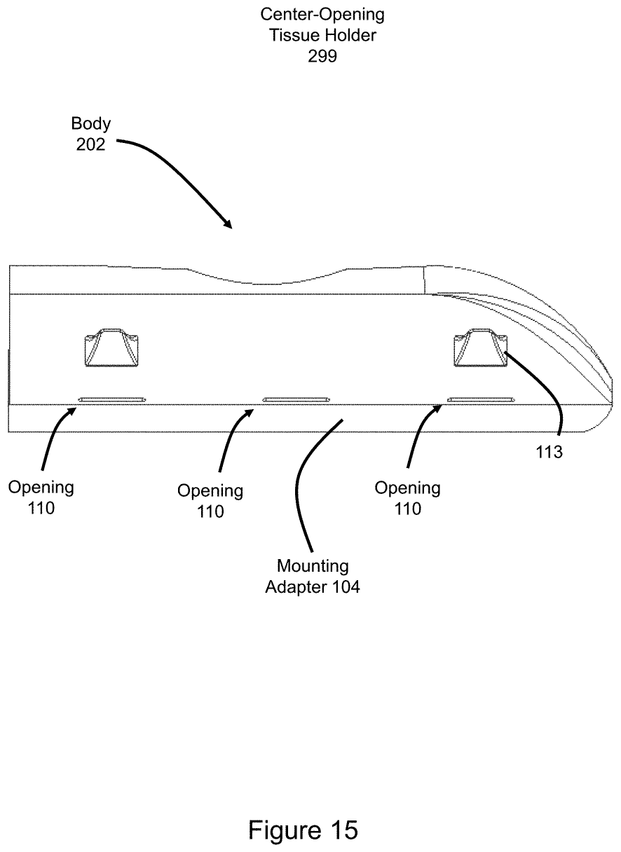

FIGS. 14 and 15 illustrate a center-opening tissue holder 299 with a hollow body 202 and mounting adapter 104. The mounting adapter 104 adapts the body for mounting to a bicycle or other equipment as already described above. The mounting adapter 104 may be placed between the body 202 and the tube in order to adapt the tissue holder to different tube curvatures.

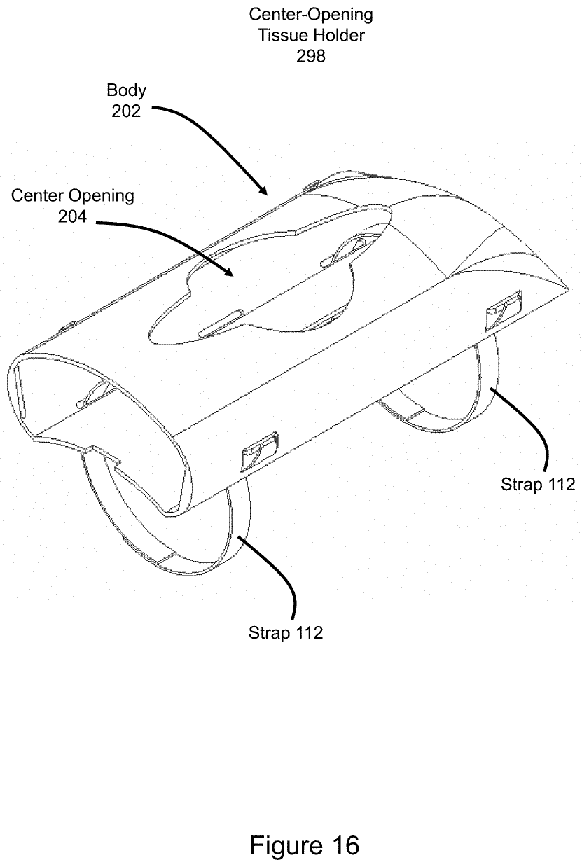

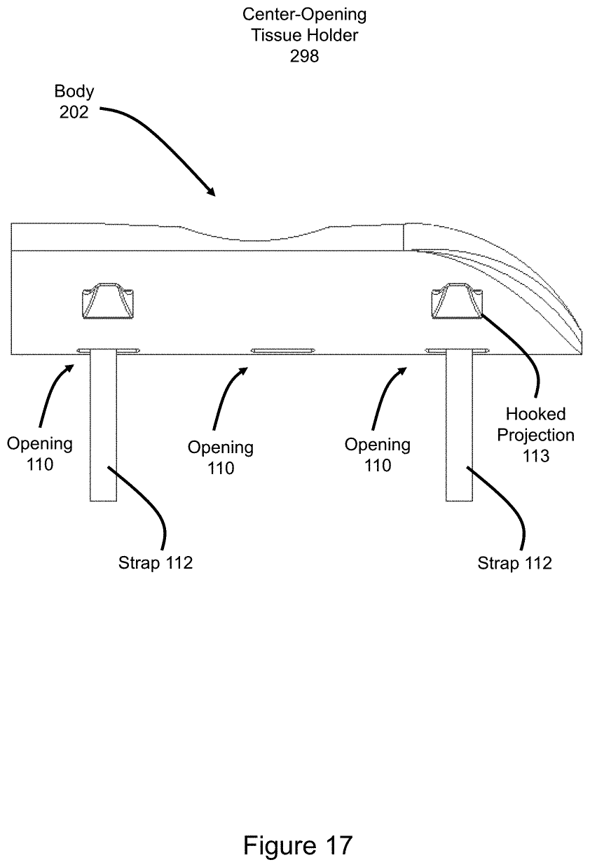

FIGS. 16 and 17 illustrate a center-opening tissue holder 298 with straps 112. Three pairs of openings 110 through which the straps 112 could be inserted are located on opposite side walls of the body. The openings are selected and used with the straps as already described above.

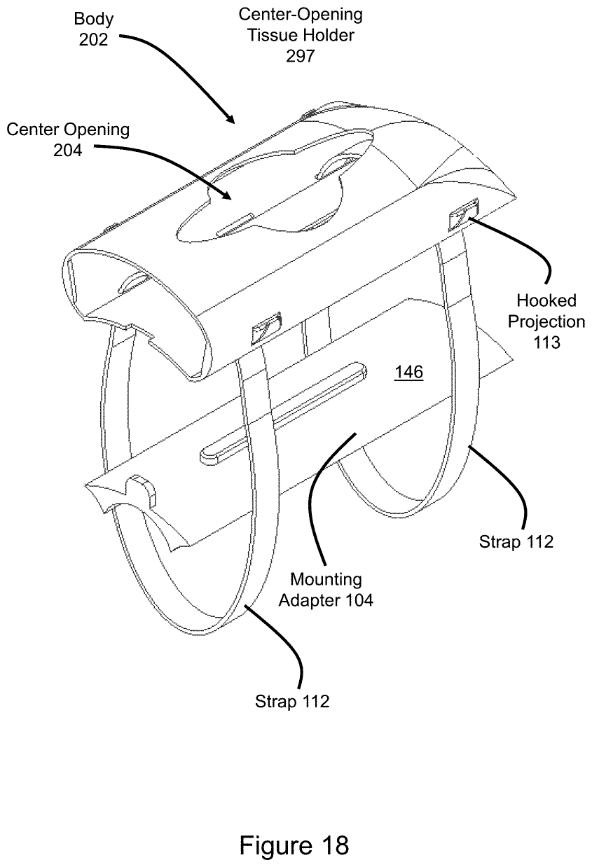

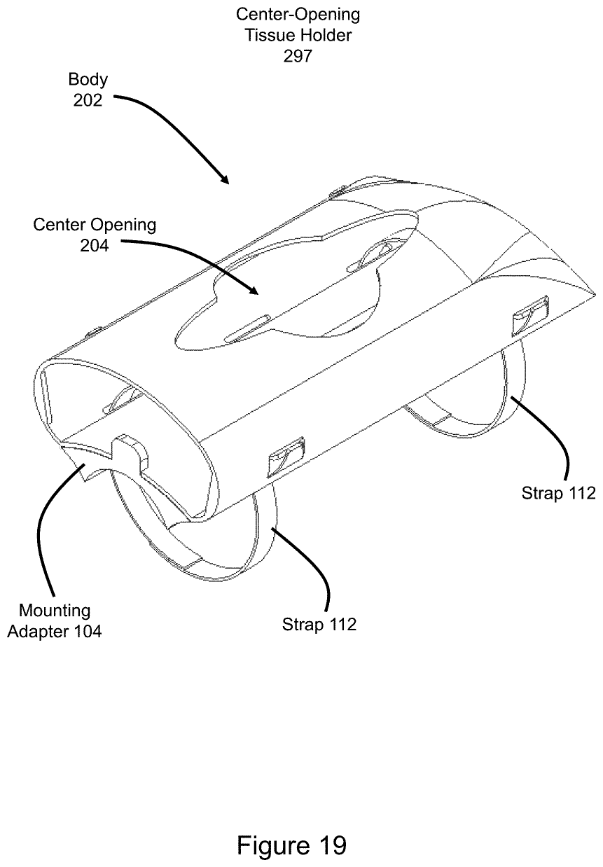

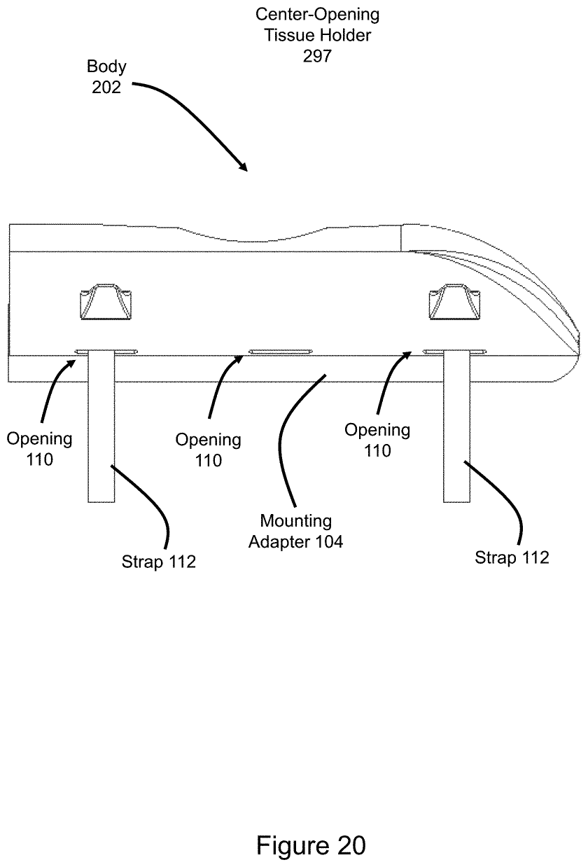

FIGS. 18 through 20 illustrate a center-opening tissue holder 297 with mounting adapter 104 and straps 112. The mounting adapter 104 adapts the body 202 for installations in which the curvature of the bottom wall of the body does not match the curvature of the tube to which the tissue holder is mounted. The straps secure the body and mounting adapter to the tube.

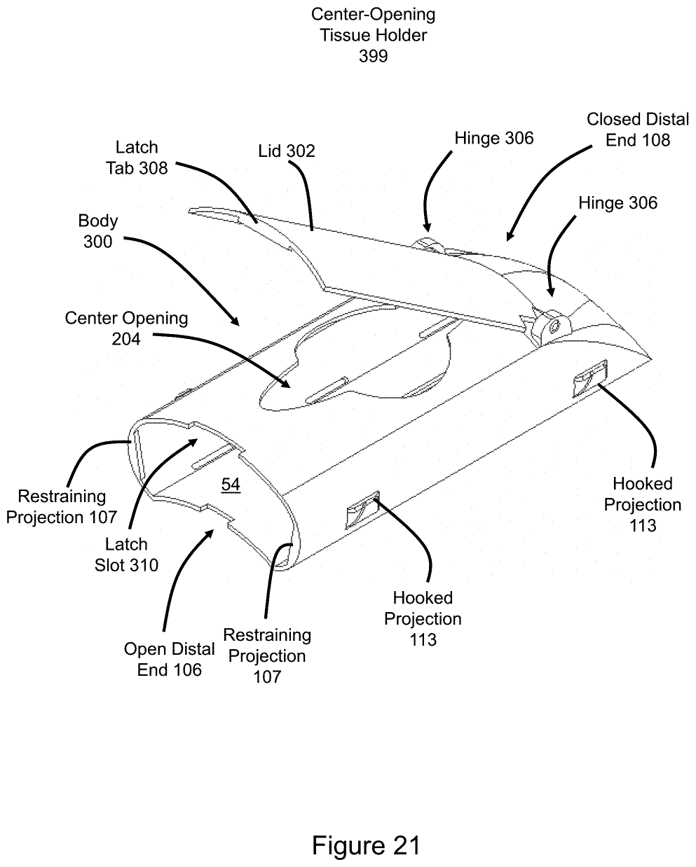

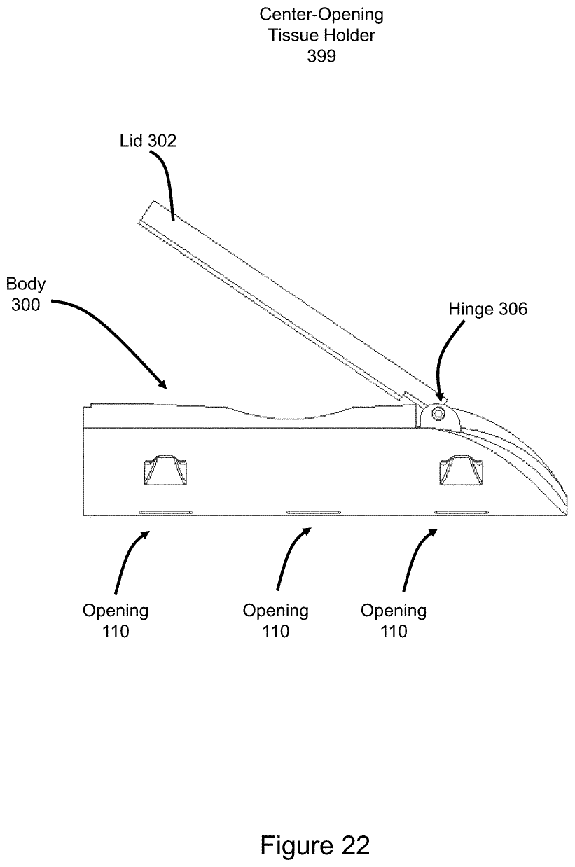

FIGS. 21 and 22 illustrate a center-opening tissue holder 399 with a hollow body 300 and a lid 302. The lid helps to protect the tissues in wet conditions. The illustrated body includes a center opening 204. The lid is connected to the body via hinges 306. The hinges enable the lid to be pivoted between an open position and a closed position. When the lid is open, tissues can be pulled through the center opening. When the lid is closed, the lid covers the center opening 204 to protect the tissues, e.g. from rain. The lid 302 may be characterized by a curvature that matches the curvature of the top wall of the body 300. Consequently, in some implementations the lid may fit snugly against the body when in the closed position. The hinges 306 may be selected to provide enough frictional force to hold the lid unattended in the open position. The lid may include a latch tab 308 at a second distal end that fits into a corresponding latch slot 310 so that the lid can be secured in the closed position. The latch feature can easily be unlatched with pressure applied by hand.

Apart from the features associated with the lid 302, the center-opening tissue holder with lid may have any or all the features described above regarding the center-opening tissue holder without lid. Tissue packages may be inserted and removed via the open distal end 106. Restraining projections 107 may be provided to retain the tissue package in place within the body. The closed distal end 108 may be aerodynamically-shaped. The bottom 54 of the body 300 may be characterized by a curvature that may match or nearly match the curvature of the tube to which the tissue holder is mounted. The tissue holder may be temporarily or permanently affixed to the bicycle using hooked projections 113 and clips, brackets, elastics, 0-rings, adhesive, fasteners, or any of a wide variety of elastic tensioners and techniques.

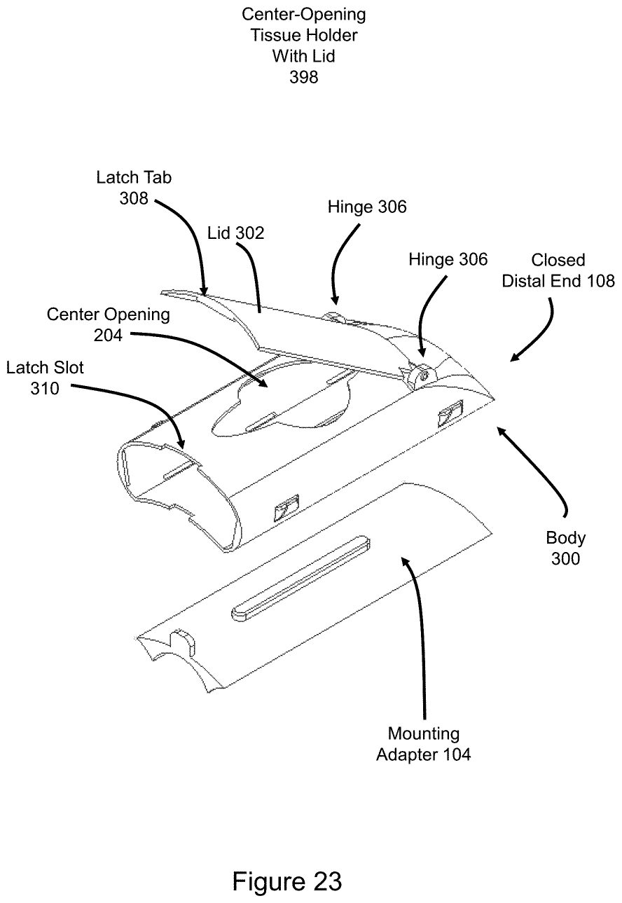

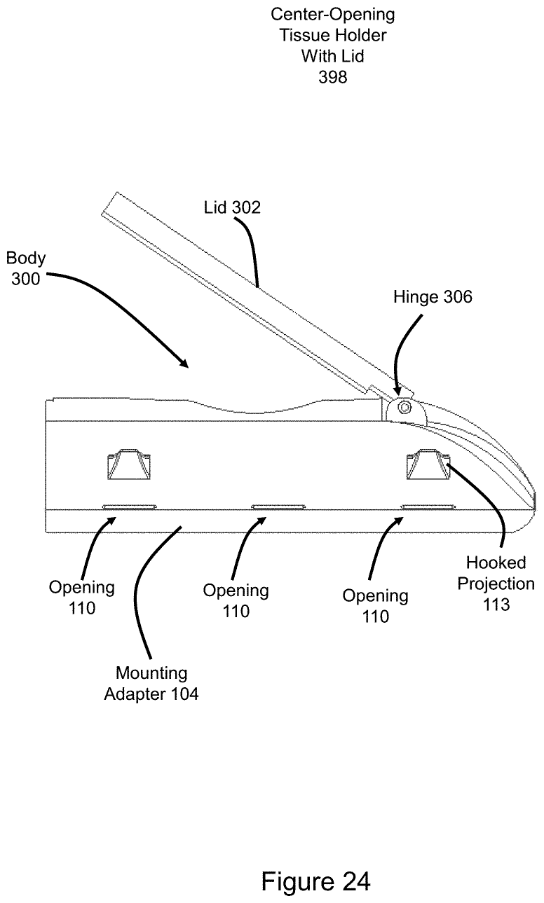

FIGS. 23 and 24 illustrate a center-opening tissue holder 398 with hollow body 300, lid 302, and mounting adapter 104. The mounting adapter 104 may be placed between the body 300 and the tube in order to adapt the tissue holder to different tube curvatures as already described above. Hooked projections 113 may be used to secure the tissue holder to a tube or other structure.

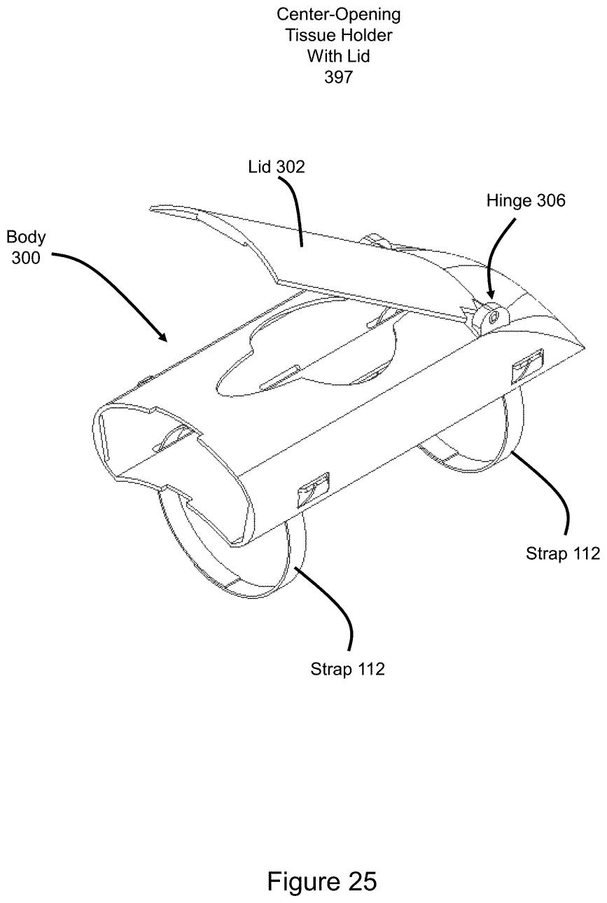

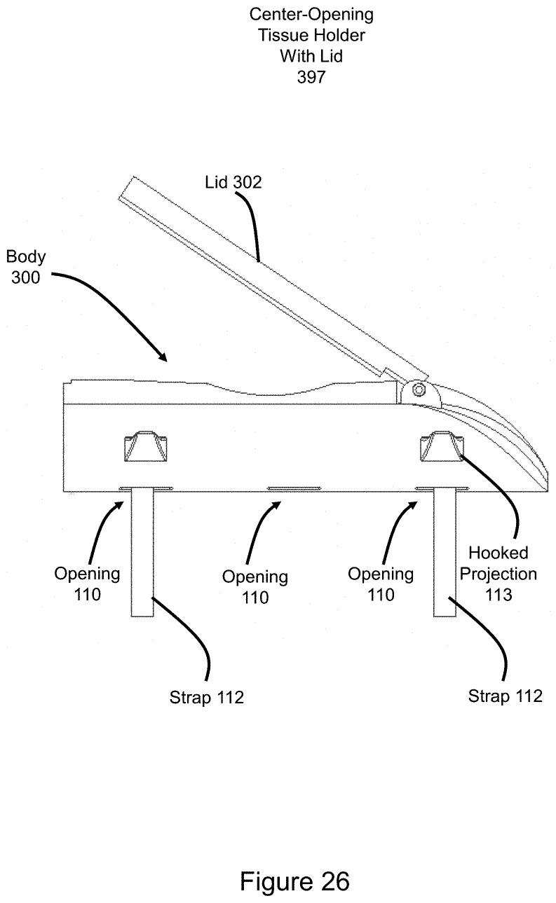

FIGS. 25 and 26 illustrate a center-opening tissue holder 397 with hollow body 300, lid 302, and straps 112. The straps attach to the body through openings 110 and secure the tissue holder to a tube or other structure as already described above.

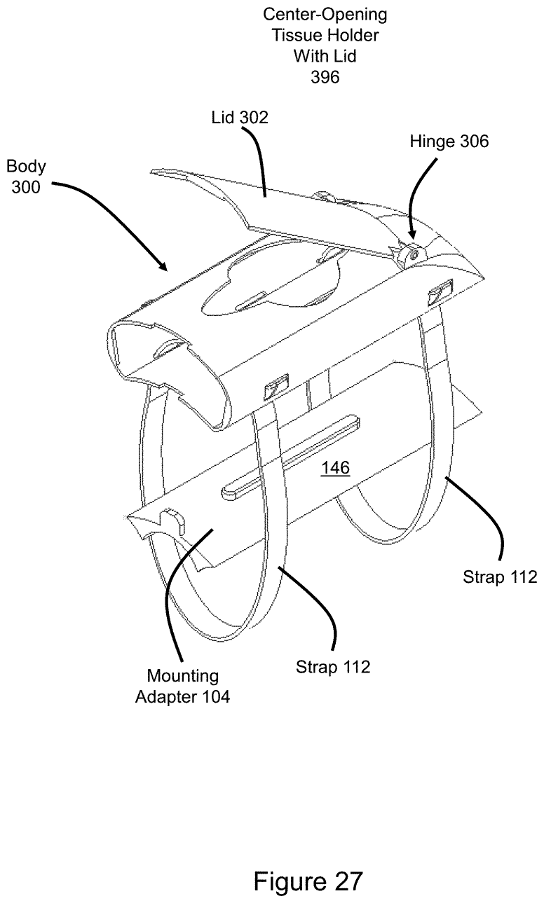

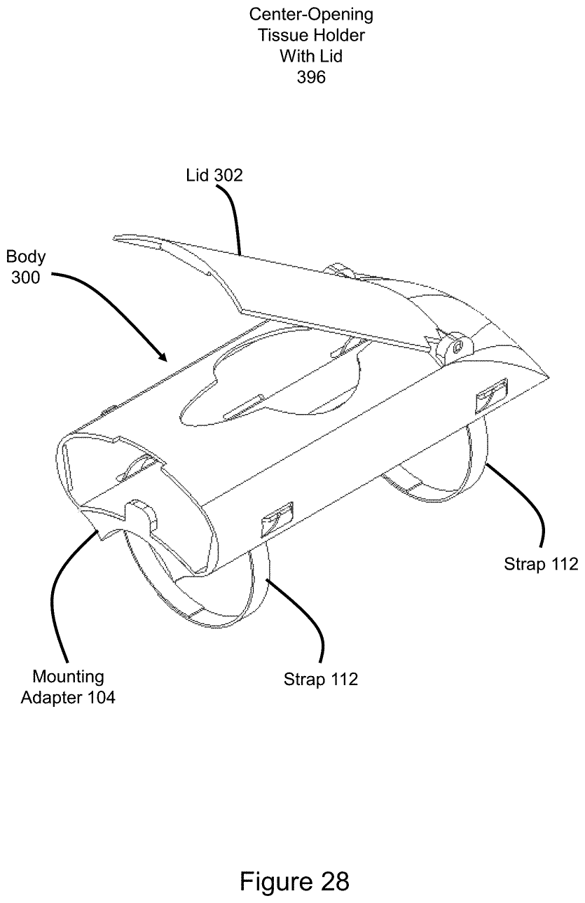

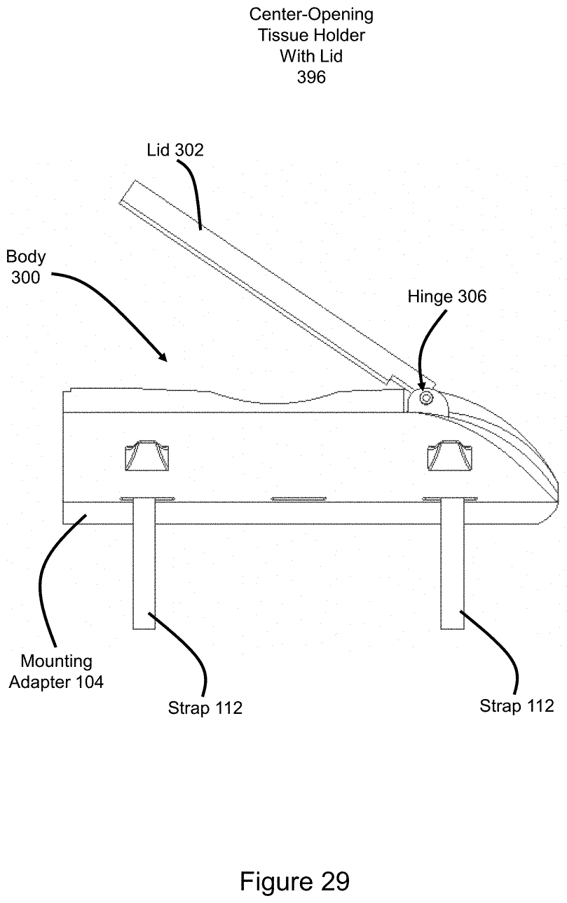

FIGS. 27 through 29 illustrate a center-opening tissue holder 396 with lid 302, straps 112, and mounting adapter 104. The mounting adapter adapts the body to be secured to a tube or other structure having a curvature that does not match the curvature of the bottom wall of the body. The straps extend around the tube or structure.

The lid variant may be implemented with the side-opening tissue holder. In such an implementation the hinges may be distributed along the length of the body rather than the width of the body as in the center-opening tissue holder with lid 300. In other words, the lid may be offset by 90 degrees relative to the lid 302 described above. The latch slot for a side-opening tissue holder with lid would be disposed proximate to lobe 105 rather than at the open distal end.

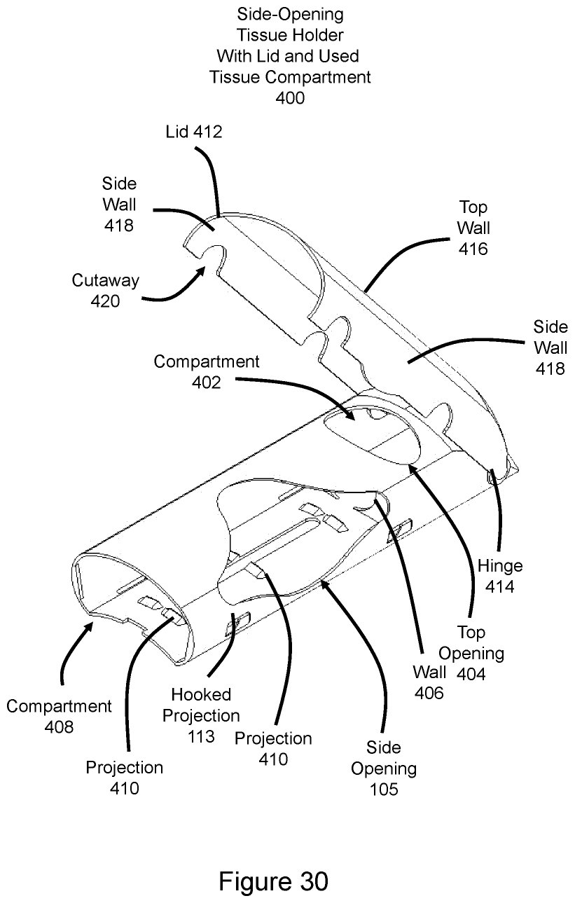

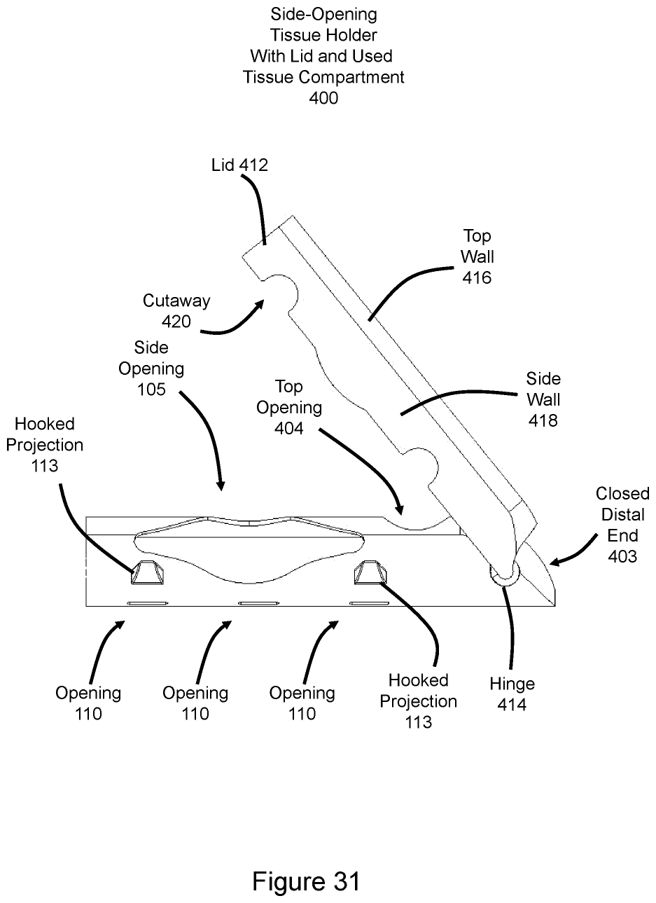

FIGS. 30 and 31 illustrate a side-opening tissue holder with lid and used tissue compartment 400. The body is extended in the length dimension to accommodate an internal compartment 402 adjacent to a closed distal end 403 for storage of used tissues. The used tissue compartment 402 is accessible via a top opening 404 in the top wall of the body. A full or partial internal wall 406 separates the used tissue compartment 402 from the main compartment 408 for holding a tissue package. Projections 410 in the bottom wall help to prevent the tissue package from sliding out of the compartment 408 due to vibration and inertia. Unused tissues are extracted from the tissue package via a side opening 105. Used tissues are temporarily placed in compartment 402 via opening 404. Openings 110 for straps and hooked projections 113 for elastic tensioners may also be included. A mounting adapter may also be used.

The tissue holder 400 includes an extended lid 412 that covers the side opening 105 and the top opening 404 in a closed position. Two hinges 414 disposed on opposite side walls of the body proximate to the closed distal end enable the lid 412 to pivot between an open position and a closed position. The lid 412 includes a top wall 416 and side walls 418 that extend over the side walls of the body in the closed position. Cutaways 420 in the side walls allow the lid to close without interference between the lid side walls and the hooked projections 113.

Although the tissue holder has been described in a configuration suitable for being mounted to a bicycle, the invention is not limited to use with a bicycle. Aspects of the invention could be adapted for mounting on a wide variety of equipment, clothing, and even a human body, e.g. for walking and hiking by attaching it to the arm or leg. Examples of equipment to which the tissue holder may be mounted include, but are not limited to, walkers and wheelchairs.

Several features, aspects, embodiments and implementations have been described. Nevertheless, it will be understood that a wide variety of modifications and combinations may be made without departing from the scope of the inventive concepts described herein.

1. An apparatus comprising:
a hollow body comprising an open distal end, a closed distal end, a top wall connected with a bottom wall via a first side wall and a second side wall, and an opening adapted to allow removal of individual tissues from a tissue package within the hollow body.

2. The apparatus of claim 1 wherein the hollow body comprises hooked projections via which the hollow body can be secured to a structure via elastic tensioners.

3. The apparatus of claim 1 wherein the hollow body comprises multiple sets of openings via which the hollow body can be secured to a structure using straps.

4. The apparatus of claim 1 wherein the opening comprises transverse lobes.

5. The apparatus of claim 1 wherein the opening comprises elongating lobes.

6. The apparatus of claim 1 wherein the opening is centered on the top wall.

7. The apparatus of claim 1 wherein the opening is centered proximate to where the top wall meets the side wall.

8. The apparatus of claim 1 wherein the hollow body comprises restraining projections at the open distal end.

9. The apparatus of claim 1 wherein the bottom wall is concave.

10. The apparatus of claim 1 wherein the first and second side walls are convex.

11. The apparatus of claim 1 wherein the top wall is convex.

12. The apparatus of claim 1 further comprising a mounting adapter having a convex side and a concave side, wherein the convex side comprises a curvature matching the bottom wall of the hollow body.

13. The apparatus of claim 12 wherein the mounting adapter comprises an alignment insert on the convex side and the hollow body includes an alignment slot on the bottom wall, the alignment insert fitting into the alignment slot.

14. The apparatus of claim 13 wherein the mounting adapter comprises a projection tab at a distal end and the hollow body comprises a slot at the open distal end, the projection tab fitting into the slot.

15. The apparatus of claim 1 comprising a lid that covers the opening in a closed position.

16. The apparatus of claim 15 comprising a hinge via which the lid is pivotally connected to the hollow body.

17. The apparatus of claim 16 wherein the lid comprises a latch tab and the hollow body comprises a latch slot, the latch tab fitting into the latch slot.

18. A tissue holder comprising:
a hollow body comprising a first compartment adapted to hold a tissue package and a second compartment adapted to hold used tissues; the hollow body comprising a first opening adapted to allow removal of individual tissues from a tissue package disposed within the first compartment and a second opening via which used tissues are placed into the second compartment.

19. The tissue holder of claim 18 comprising a hinged lid that covers the first opening and the second opening in a closed position.

20. A tissue holder comprising:
a hollow body comprising an opening adapted to allow removal of individual tissues from a tissue package disposed within the hollow body;
a hinged lid that covers the opening in a closed position;
means for attaching the hollow body to a structural member; and
a mounting adapter configured to be disposed between the hollow body and the structural member.
